(19) United States
(12) Patent Application Publication
(10) Pub. No.: US 2015/0263641 A1
(43) Pub. Date: Sep. 17, 2015

(54) INVERTER DEVICE

(71) Applicant: Sanyo Electric Co., Ltd., Osaka (JP)

(72) Inventors: Yoshinori NORITAKE, Gunma (JP); Kiyoma YAMAGISHI, Gunma (JP)

(21) Appl. No.: 14/636,833

(22) Filed: Mar. 3, 2015

(30) Foreign Application Priority Data
Mar. 11, 2014 (JP) 2014-047178
Dec. 4, 2014 (JP) 2014-245536

(51) Int. Cl. H02M 7/06

(52) U.S. Cl. CPC H02M 7/06

(57) ABSTRACT

An inverter device, including: a booster circuit that includes a switch element and a booster coil, the booster circuit boosting a voltage of direct-current power by the switch element being driven using a first on-off signal; an inverter circuit that includes switch elements, the inverter circuit converting the direct-current power, which is outputted from the booster circuit, into alternating-current power by the switch elements being driven using a second on-off signal; a coil for filter through which the alternating-current power passes; and a control unit configured to drive (i) the switch element using the first on-off signal for which a duty cycle is changed according to a first frequency, and (ii) the switch elements using the second on-off signal generated based on a carrier wave having a second frequency higher than a first frequency and a modulation wave having a frequency which synchronizes to a frequency of a power grid.

### CROSS REFERENCE TO RELATED APPLICATIONS

This application claims the benefit of priority of Japanese Patent Application Number 2014-245536, filed on Dec. 4, 2014, and Japanese Patent Application Number 2014-047178, filed on Mar. 11, 2014, the entire content of which is hereby incorporated by reference.

### TECHNICAL FIELD

The disclosure relates to inverter devices that boost a voltage of direct-current power and convert the direct-current power into alternating-current power.

### BACKGROUND ART

Provided is an inverter device that causes (i) a booster circuit to boost a voltage of direct-current power based on natural energy such as solar power generation, wind power generation, geothermal power generation, and wave power generation, and a voltage of direct-current power outputted from storage batteries, fuel cells, and so on, and (ii) an inverter circuit to convert the direct-current power into alternating-current power which synchronizes to a power grid, and supplies the alternating-current power to the power grid.

The booster circuit periodically turns a switch element on and off, and boosts a voltage of direct-current power by intermittently passing a current through a coil. Examples of the booster circuit include a chopper booster circuit and an insulated booster circuit including a transformer. The inverter circuit converts direct-current power into alternating-current power. Examples of the inverter circuit include an inverter circuit including switch elements connected in a single-phase bridge or a mufti-phase bridge. The direct-current power is converted into a pseudo sine wave by periodically turning the switch elements of the inverter circuit on and off based on the pulse-width modulation (PWM). This pseudo sine wave is formed into a sine wave by a filter circuit attenuating a high-frequency component of the pseudo sine wave, and the sine wave is supplied to the power grid.

An inverter device is proposed that uses, as a frequency at which switch elements of an inverter circuit are periodically turned on and off, a high value such as approximately 20 KHz at near zero (at near electrical angles of 0° and 180° where an instantaneous value of a converted alternating-current output current is less than or equal to a threshold value, and reduces a frequency to approximately 15 KHz in other cases (refer to Japanese Unexamined Patent Application Publication No. 2013-55794, for example). With this, a frequency at which the switch elements are turned on and off is low in a range where the instantaneous value of the alternating-current output current is greater than or equal to the threshold value. Thus, the inverter device changes a frequency at which the switch elements are turned on and off in one period, to reduce the number of times the switch elements are turned on and off to 88 times per period, and suppresses switching loss in the inverter circuit accordingly.

### SUMMARY

Unfortunately, generally speaking, when switch elements are turned on and off, a frequency at which the switch elements are turned on and off is emitted as noise into the environment if the frequency is in an audible range. A human audible range is up to approximately 20 KHz. Although the human audible range varies with age and between individuals, high frequencies become unpleasant noise called mosquito sound. It is to be noted that noise emitted at a frequency of approximately 20 KHz is normally beyond the audible range, and thus users have difficulty hearing the noise and noise suppression is achieved. The above-described inverter device is expected to produce a noise suppression effect by combining a frequency of 20 KHz and a frequency of 15 KHz, when the frequency of 20 KHz is applied to the inverter device, but the switching loss increases. In addition, generally speaking, the frequency of 15 KHz is often applied to the inverter device, and the inverter device fails to suppress noise at this frequency. Thus, such an inverter device is unsuitable for a general household requiring quietness.

Moreover, although an inverter device temporarily increases an on-off frequency of switch elements when it is sensed that a person approaches the inverter device, it is difficult to achieve both switching loss and quietness by merely changing a frequency uniformly in consideration of individual differences in the audible range. Furthermore, noise results from a vibration of a coil through which a current is intermittently passed when the switch elements are turned on and off, and a frequency of the vibration is based on a frequency at which the switch elements are turned on and off. The coil itself is molded with resin or the like to suppress the vibration of the coil, but if the coil is fixed to a housing, even a tiny vibration is amplified via the housing and emitted as noise. An object of the disclosure is to provide an inverter device that generally suppresses noise emitted from the inverter device.

An inverter device, including: a housing; a booster circuit that is fixed to the housing and includes one or more switch elements and a booster coil, the booster circuit boosting a voltage of direct-current power to a target voltage by a current being intermittently passed through the booster coil by the one or more switch elements being driven using a first on-off signal; an inverter circuit that is fixed to the housing and includes a plurality of switch elements, the inverter circuit converting the direct-current power, which is outputted from the booster circuit, into alternating-current power by the plurality of switch elements being driven using a second on-off signal; a coil for filter that is fixed to the housing and through which the alternating-current power resulting from the conversion by the inverter circuit passes; and a control unit configured to drive (i) the one or more switch elements using the first on-off signal for which a duty cycle is changed in one period corresponding to a first frequency, and (ii) the plurality of switch elements using the second on-off signal generated through the pulse-width modulation (PWM) based on a carrier wave having a second frequency higher than the first frequency and a modulation wave having a frequency which synchronizes to a frequency of the power grid.

An inverter device including a booster circuit and an inverter circuit suppresses noise on an output side of the inverter circuit.

### BRIEF DESCRIPTION OF THE DRAWINGS

The figures depict one or more implementations in accordance with the present teaching, by way of examples only, not by way of limitations. In the figures, like reference numerals refer to the same or similar elements.

FIG. 1 is a diagram illustrating an inverter device according to an embodiment of the present invention.

FIG. 2 is a diagram illustrating control blocks of a control circuit.

FIG. 3A is a time chart of a power grid voltage Vo of a power grid.

FIG. 3B is a time chart of a first carrier signal C1 and a first signal t1.

FIG. 3C is a time chart of a pulse signal S1 applied to a switch element.

FIG. 3D is a time chart of a second carrier signal C2 and a command signal t2.

FIG. 3E is a time chart of a portion of a pulse signal S2a applied to a switch element.

FIG. 3F is a partially enlarged diagram of FIG. 3C.

FIG. 3G is a partially enlarged diagram of FIG. 3E.

FIG. 4 is a diagram indicating an operation unit according to an embodiment of the present invention.

### DETAILED DESCRIPTION

Hereinafter, an embodiment is described in detail with reference to the Drawings. It is to be noted that the same reference signs are assigned to the same or corresponding parts in the figures, and descriptions thereof are omitted.

The embodiment described below shows a specific example of the present invention. The numerical values, shapes, materials, structural elements, the arrangement and connection of the structural elements, steps, the processing order of the steps etc. shown in the following embodiment are mere examples, and therefore do not limit the scope of the present invention. The present invention is specified by the appended Claims. Therefore, among the structural elements in the following embodiment, structural elements not recited in the independent claim defining the most generic part of the inventive concept are not always necessary to solve a problem of the present invention, but are described as elements constituting a more preferred embodiment.

The embodiment produces a noise suppression effect for an output side of an inverter circuit by setting a switching period of switch elements in the inverter circuit to be shorter than a switching period of a switch element in a booster circuit.

### Embodiment

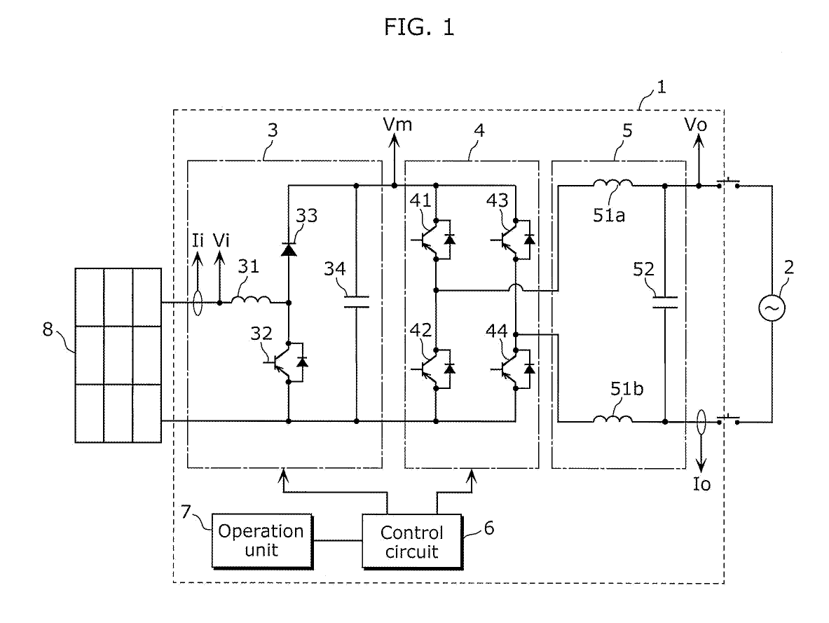

FIG. 1 is a diagram illustrating an inverter device according to an embodiment of the present invention. As illustrated in FIG. 1, an inverter device 1 is connected to a solar panel 8, converts direct-current power outputted by the solar panel 8 into alternating-current power which synchronizes to a power grid 2, and supplies the alternating-current power to the power grid 2.

The inverter device 1 includes a booster circuit 3, an inverter circuit 4, a filter circuit 5, a control circuit (control unit) 6, and an operation unit 7.

The booster circuit 3 configures a non-insulated chopper (choke converter) circuit using a direct-current reactor (reactor for boosting) 31, a switch element 32 for chopping, a diode 33, and a capacitor 34. The direct-current reactor 31 is a coil wound around a core material to have predetermined inductance, and is fixed to a housing (which is not shown, is a box-like housing formed by aluminum die casting or sheet-metal processing, and is fixed to a wall surface of a house or a stand) without losing heat conductivity (heat dissipation). It is to be noted that the direct-current reactor 31 may be fixed to a heat sink unit. Thus, the direct-current reactor 31 not only radiates heat to the housing or the heat sink unit but also transmits a vibration to the housing or the heat sink unit. It is to be noted that the booster circuit 3 is not limited to the chopper circuit, but may be an insulated forward converter circuit that performs boosting by intermittently controlling passing of a current through a coil on a primary side of a transformer, a current source booster circuit, and so on. In the booster circuit 3, the primary side of the transformer can be formed into a half-bridge configuration or a full-bridge configuration using switch elements. A rectifier circuit is used for a secondary side of the transformer.

The direct-current reactor 31 has one end connected to one end (an anode side) of the diode 33, and the switch element 32 has one end connected to the connection point. The direct-current reactor 31 has the other end connected to a positive side of the solar panel 8, and the switch element 32 has the other end connected to a negative side of the solar panel 8.

The capacitor 34 is connected to the other end (a cathode side) of the diode 33 and the negative side of the solar panel 8 (the other end of the switch element 32). A direct current outputted from the solar panel 8 is intermittently passed through the direct-current reactor 31 by periodically turning the switch element 32 on and off, and a voltage of the direct current is boosted. The capacitor 34 attenuates (smoothes) a high-frequency component resulting from a frequency at which the switch element 32 is turned on and off. The output (direct-current power) from the capacitor 34 is supplied to the inverter circuit 4. The booster circuit 3 variably controls a duty cycle in which the switch element 32 is periodically turned on and off so that an output voltage Vm is held at a target voltage. When receiving the direct-current power from the solar panel 8, the booster circuit 3 performs maximum power point tracking (MPPT) for variably controlling a value of the target voltage Vm so that generated power (product of input current Ii and input voltage Vi) of the solar panel 8 reaches the maximum power. It is to be noted that the target voltage Vm can be a fixed value using a storage battery, for instance, when an output voltage of the storage battery is stable. An on-off operation for the switch element 32 is described later.

The inverter circuit 4 has switch elements 41 to 44 for inverter, and includes a single-phase bridge circuit in which a series circuit in which the switch elements 41 and 42 are sequentially connected in series, and a series circuit in which the switch elements 43 and 44 are sequentially connected in series, are connected in parallel. One connection point of the two series circuits is connected to the other end of the diode 33 of the booster circuit 3 (output of the capacitor 34), and the other connection point of the two series circuits is connected to the other end of the switch element 32 of the booster circuit 3. It is to be noted that the inverter circuit 4 may be a mufti-level inverter circuit such as a neutral-point-clamped (NPC) inverter and a gradation inverter, as long as the mufti-level inverter converts a direct current into an alternating current (a pseudo sine wave chopped at a high frequency). In addition, by using a mufti-phase bridge circuit including a three-phase bridge circuit but not limited to a single-phase bridge circuit, it is also possible to convert a direct current into a mufti-phase alternating current.

Those switch elements 41 to 44 are driven by on-off signals based on the pulse-width modulation (PWM) in which a carrier wave of a predetermined frequency (a second frequency) and a modulation wave of a frequency which synchronizes to the power grid 2 are used. It is to be noted that in the PWM not only a carrier wave and a modulation wave are directly compared, but also direct calculation by computing or a lookup table including pre-calculated data may be used. On-off operations for the switch elements 41 to 44 are described later.

The filter circuit 5 configures a low-pass filter that is connected between the inverter circuit 4 and the power grid 2 and attenuates a high-frequency component of alternating-current power outputted by the inverter circuit 4, into a waveform similar to that of a sine wave. This waveform is supplied as the alternating-current power to the power grid 2 via a relay. Specifically, the filter circuit 5 includes: alternating-current reactors (coils for filter) 51a and 51b that are disposed on a pair of lines extending from between the switch elements 41 and 42 and from between the switch elements 43 and 44; and a capacitor 52 that connects the alternating-current reactors 51a and 51b and the power grid 2. The alternating-current reactors 51a and 51b are coils wound around the same core materials to have predetermined inductance, and are fixed to a housing without losing heat conductivity (heat dissipation). Thus, the alternating-current reactors 51a and 51b not only radiate heat to the housing but also transmit vibrations to the housing.

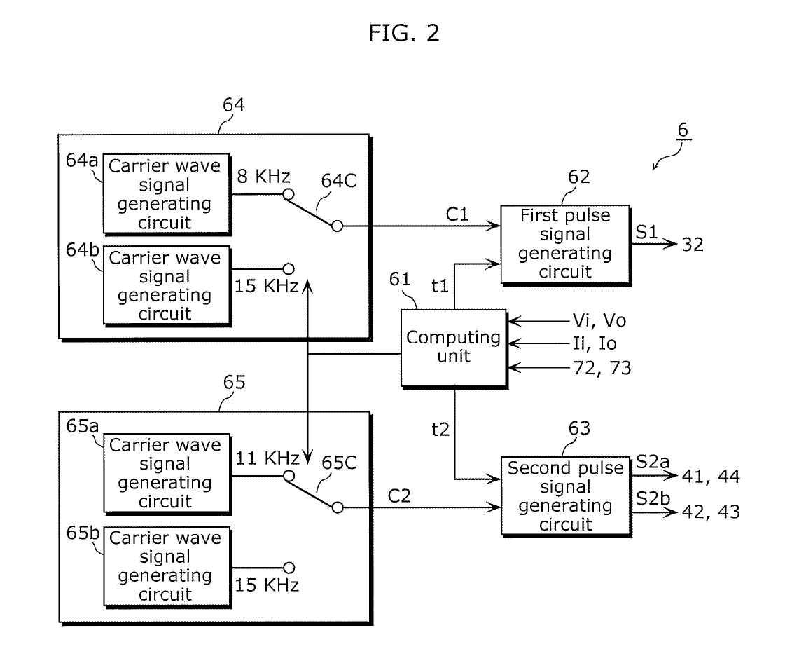

FIG. 2 is a diagram illustrating control blocks of a control circuit. The control circuit 6 generates pulse signals (on-off signals) S1, S2a, and S2b, and controls an on-off operation for the switch element 32 of the booster circuit 3 with the pulse signal S1 (a first pulse signal), and on-off operations for the switch elements 41 to 44 of the inverter circuit 4 with the pulse signals S2a and S2b (second pulse signals). It is to be noted that since the pulse signal S2b is an inversion of the pulse signal S2a, the following description mainly focuses on the pulse signal S2a. As illustrated in FIG. 2, the control circuit 6 includes a computing unit 61, a first pulse signal generating circuit 62, a second pulse signal generating circuit 63, a first carrier signal generating circuit 64 that generates a first carrier signal C1, and a second carrier signal generating circuit 65 that generates a second carrier signal C2.

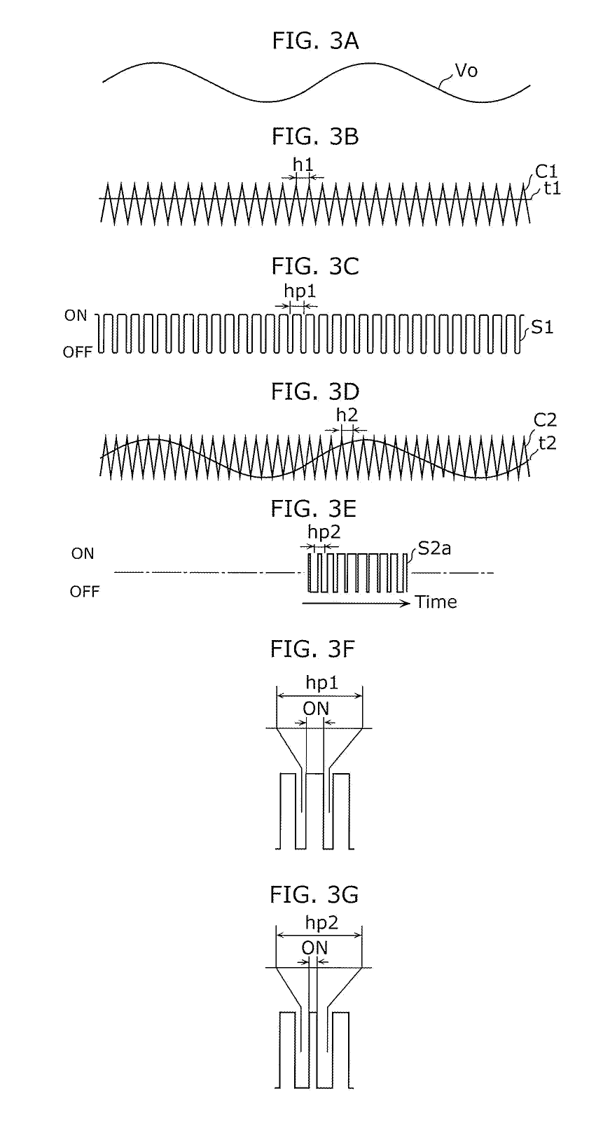

The pulse signal S1 illustrated in FIG. 3C is a first on-off signal obtained by modulating (comparing magnitude of) a carrier wave (a first carrier signal) C1 in a predetermined period hp1 (corresponding to a first frequency) illustrated in FIG. 3B and a first signal t1. FIG. 3F is a partially enlarged diagram of FIG. 3C, and an ON signal component is in the period hp1. This ON signal is for repeatedly turning the switch element 32 on and off in every period hp1, and is provided as the pulse signal S1 to the switch element 32. The switch element 32 is repeatedly turned on and off according to this signal, and allows a current to be intermittently passed through the direct-current reactor (coil for boosting) 31 and a direct-current voltage to be boosted together with the diode 33 and the capacitor 34. A boosting ratio (boosting amount) can be adjusted by changing an ON time (duty cycle) in the period hp1 by changing a value (level) of the first signal t1 illustrated in FIG. 3B. The control circuit 6 controls an ON time (duty cycle) of the pulse signal S1 so that an output of the solar panel 8 reaches the maximum power. It is to be noted that the coil of the direct-current reactor 31 vibrates according to the period hp1 due to the intermittent supply of the current to the direct-current reactor 31, and this vibration is transmitted to the housing and emitted into the environment. The magnitude of the vibration is influenced by a ripple of a voltage variation of the capacitor 34.

The computing unit 61 changes the first signal t1 so that power P computed from the input current Ii and the input voltage Vi to the booster circuit 3 reaches the maximum power.

Control of the first signal t1 by the computing unit 61 is performed as follows. The computing unit 61 records whether the first signal t1 (a value representing magnitude) is previously increased or decreased, and adjusts the first signal t1 in the same direction as before (increases the first signal t1 in the case where the first signal t1 is increased previously or decreases the first signal t1 in the case where the first signal t1 is decreased previously) when the power P increases. In addition, the computing unit 61 adjusts the first signal t1 in a direction opposite the previous direction (decreases the first signal t1 in the case where the first signal t1 is increased previously or increases the first signal t1 in the case where the first signal t1 is decreased previously) when the power P previously decreases.

FIG. 3B is a time chart of a first signal t1 and a first carrier signal C1 (a value repeatedly changing in a triangular waveform continuously). FIG. 3C is a time chart of a pulse signal S1. When the computing unit 61 generates the first signal t1, the first pulse signal generating circuit 62 controls (generates) the first pulse signal S1 using the first signal t1 and the first carrier signal C1. Here, the first pulse signal generating circuit 62 compares values of the first signal t1 and the first carrier signal C1, and, for instance, generates the pulse signal S1 in OFF state (Low) in the case where the first signal t1 is greater than the first carrier signal C1, and the pulse signal S1 in ON state (High) in the case where the first signal t1 is less than the first carrier signal C1. Thus, the pulse signal S1 has its pulse width (ON time for a switch element) controlled according to the value of the first signal t1, and a period hp1 of the pulse signal S1 is set to be the same as a period h1 of the first carrier signal C1.

The pulse signals S2a and S2b (inversion of the pulse signal S2a) each are a second on-off signal for repeatedly turning the switch elements 41 to 44 on and off in every predetermined period hp2. The switch elements 41 to 44 are repeatedly turned on and off in response to the pulse signals S2a and S2b. FIG. 3A is a time chart of a power grid voltage Vo of the power grid 2. FIG. 3D is a time chart of a command signal t2 and a second carrier signal C2 (a value repeatedly changing in a triangular waveform continuously), and FIG. 3E is a time chart of a portion of the pulse signal S2a. FIG. 3G is a partially enlarged diagram of FIG. 3E. As illustrated in these figures, the pulse signal S2a is a result of comparing values of a command signal (a modulation wave) t2 of a frequency which synchronizes to the power grid voltage Vo and the second carrier signal C2. In addition, the pulse signal S2b is a value obtained by inverting the pulse signal S2a.

The pulse signal S2a is inputted to the switch elements 41 and 44, and the pulse signal S2b is inputted to the switch elements 42 and 43. With this, the inverter circuit 4 alternately turns the switch elements 41 and 44 and the switch elements 42 and 43 on and off, to convert direct-current power into alternating-current power. It is to be noted that transmission of the pulse signals S2a and S2b for on-off driving of the switch elements 41 to 44 may be delayed so that the switch elements 41 to 44 configuring the same series circuits are not simultaneously turned on, or may be adjusted when the pulse signals S2a and S2b are generated.

A timing at which the pulse signals S2a and S2b are repeatedly set to be in the ON-state and the OFF-state is determined by the computing unit 61 computing a command signal (a command signal becomes a sine waveform chronologically which synchronizes to the power grid voltage Vo) of an output current, and by the second pulse signal generating circuit 63 comparing values of the second carrier signal C2 and the command signal t2 (a second signal).

For example, the pulse signal S2a in the OFF-state (Low) is generated in the case where the command signal t2 is greater than the second carrier signal C2, and the pulse signal S2a in the ON-state (High) is generated in the case where the command signal t2 is less than the second carrier signal C2.

In this manner, the control circuit 6 controls the on-off operations for the switch elements 41 to 44 for inverter according to the pulse signals S2a and S2b so that a frequency synchronizes to an alternating-current waveform of the power grid. It is to be noted that this synchronization timing can be delayed when reactive power is controlled. In addition, since the pulse signals S2a and S2b are generated as stated above, periods of the pulse signals S2a and S2b are the same as a period of a carrier wave, and pulse widths (duty cycles) of the pulse signals S2a and S2b increase or decrease in synchronization with amplitude of the command signal t2.

It is to be noted that the first signal t1, the pulse signal S1, the command signal t2, and the pulse signals S2a and S2b may be computed in a microprocessor or may be generated by an analog circuit or the like. In addition, these signals may be extracted from pre-calculated data and a lookup table.

A user can manually select with the operation unit 7 whether to cause the inverter device 1 (the booster circuit 3 and the inverter circuit 4) according to the embodiment to operate in a power mode (a first mode) in which conversion efficiency is high, and to operate in a quiet mode (a second mode) in which noise is suppressed.

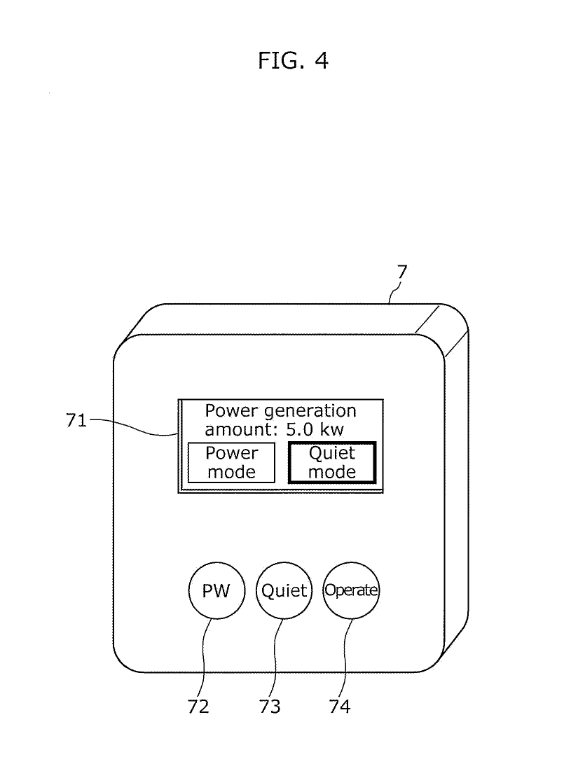

The operation unit 7 is capable of performing wired or wireless communication with the control circuit 6. Moreover, as illustrated in FIG. 4, the operation unit 7 includes: a display unit 71; a first button 72 for selecting an operation in the power mode; a second button 73 for selecting an operation in the quiet mode; and a third button 74 for selecting operation/stop of the inverter device 1.

The display unit 71 displays which mode is being used. Here, characters indicating an operation mode are enclosed by a heavy line. In addition, the display unit 71 also simultaneously displays generated power of the solar panel 8, for instance. In the power mode (a case where the first carrier signal generating circuit 64 and the second carrier signal generating circuit 65 are selected to be in a state illustrated in FIG. 2), the first carrier signal C1 outputted by the first carrier signal generating circuit 64 and the second carrier signal C2 outputted by the second carrier signal generating circuit 65 are set to be at 8 KHz (a period of 0.125 msec) and 11 KHz (a period of 0.09 msec), respectively. When the power mode is selected, the periods of the pulse signals S2a and S2b are set to be shorter than the period of the pulse signal S1 (the frequencies of the pulse signals S2a and S2b are set to be higher). A frequency of a carrier signal is not limited to one of those values, but may be a value such as 10 KHz, 13 KHz, and 15 KHz higher than the frequency of the first carrier signal C1.

For example, when a FET is used for the switch element 32, setting the frequency of first carrier signal C1 to approximately 8 KHz results in high conversion efficiency due to characteristics of the FET. The frequency of the first carrier signal C1, however, is not limited to 8 KHz. When a switch element such as a MOSFET, an IGBT, and an SiC transistor, a frequency with which conversion efficiency is increased may be used depending on characteristics of the switch element to be used. When the period of the second carrier signal C2 is set to be the same as that of the first carrier signal C1, conversion efficiency of the inverter circuit 4 is increased, but the inverter circuit 4 together with the switch element 32 emits a greater amount of noise to the environment.

By setting the frequency of the second carrier signal C2 to be higher than that of the first carrier signal C1, the number of times the switch element of the inverter circuit 4 is turned on and off is increased by a number of times based on a difference frequency, and switching loss also increases. The filter circuit 5, however, reduces a voltage fluctuation (an amount of wave distortion) for a ripple component superimposed on alternating-current power (a sine wave) as much as the increase in the frequency. As a result, sound pressure of noise emitted to the environment decreases, and an amount of entire noise is reduced accordingly. Moreover, since the second carrier signal C2 has the higher frequency, some users have difficulty hearing this frequency because of individual variation, and a noise suppression effect can be expected on the whole. It is possible to set the frequency of the second carrier signal C2 appropriately because the noise suppression effect becomes greater with an increase in the frequency. Since the number of switch elements used for the inverter circuit 4 is greater than the number of switch elements used for the booster circuit 3, the noise suppression effect is more easily produced by setting the frequency of the second carrier signal C2 to be higher than that of the first carrier signal C1.

When the quiet mode is selected, the period of the pulse signal 51 and the periods of the pulse signals S2a and S2b are set to be substantially equal. (The periods of the first and second carrier signals are changed.) In the quiet mode (a case where the first carrier signal generating circuit 64 and the second carrier signal generating circuit 65 are selected to be in a state opposite the state illustrated in FIG. 2), the frequency of the first carrier signal C1 outputted by the first carrier signal generating circuit 64 and the frequency of the second carrier signal C2 are set to be 15 KHz (a period of 0.067 msec). Some users have difficulty hearing this frequency because of individual variation, and the frequency is expected to bring a quiet effect. It is to be noted that the frequency may be much higher if a trade-off with switching loss is favorable. In this case, switching loss when the switching elements are turned on and off increases with an increase in the respective frequencies, but the quiet effect can be preferentially expected.

In the embodiment, as illustrated in FIG. 4, the first carrier signal generating circuit 64 and the second carrier signal generating circuit 65 respectively include carrier signal generating circuits 64a, 64b, 65a, and 65b having different frequencies, and the carrier signal generating circuits that transmit the first carrier signal C1 and the second carrier signal C2 to the first pulse signal generating circuit 62 and the second pulse signal generating circuit 63 can be selected by switching circuits 64c and 65c.

When turned on and off, the switch element 32 of the booster circuit 3 and the switch elements 41 to 44 of the inverter circuit 4 generate noise on output sides due to an influence of the on-off operations. The booster circuit 3, however, has the capacitor 34 that is disposed on an output side and substantially serves as a low-pass filter, and thus has little impact on noise generated by the inverter circuit 4 even when a period of an on-off operation is shortened in comparison to the switch elements 41 to 44 for inverter.

Thus, as in the embodiment, by setting the period of the second pulse signal (a period of an on-off operation for the inverter circuit 4) to be shorter than that of the first pulse signal provided to the booster circuit 3 (a period of an on-off operation for the booster circuit 3), it is possible to reduce the switching loss of the booster circuit 3 while suppressing the noise of the inverter circuit 4 to the output side.

Moreover, due to the on-off operation for the switch element 32 of the booster circuit 3 and the on-off operations for the switch elements 41 to 44 of the inverter circuit 4, the direct-current reactor 31 and the alternating-current reactors 51a and 51b vibrate at a substantially same frequency (period) as a frequency (period) of those on-off operations, and this vibration is transmitted as sound to the outside. This sound is less likely to be heard easily as the frequency increases, and thus, as in the embodiment, by making the period of the first pulse signal and the period of the second pulse signal variable to allow the inverter device 1 to operate in the power mode and the quiet mode, it is possible to cause the inverter device 1 to operate quietly (shorten a period of an on-off operation) in the quiet mode when sound is annoying in the power mode (the period of the on-off operation is long).

Although the embodiment of the present invention has been thus far described, the above description is for facilitating understanding of the present invention, and does not limit the present invention. The embodiment may be modified or varied within the scope of the present invention, and it goes without saying that equivalents thereof fall within the scope of the present invention.

The inverter device according to the embodiment of the present invention can be used as, for instance, a solar power generation system including the solar panel 8. In addition, the inverter device according to the embodiment of the present invention is for outputting single-phase alternating-current power, but may be applied to output three-phase alternating-current power.

1. An inverter device, comprising:
a housing;
a booster circuit that is fixed to the housing and includes one or more switch elements and a booster coil, the booster circuit boosting a voltage of direct-current power to a target voltage by a current being intermittently passed through the booster coil by the one or more switch elements being driven using a first on-off signal;
an inverter circuit that is fixed to the housing and includes a plurality of switch elements, the inverter circuit converting the direct-current power, which is outputted from the booster circuit, into alternating-current power by the plurality of switch elements being driven using a second on-off signal;
a coil for filter that is fixed to the housing and through which the alternating-current power resulting from the conversion by the inverter circuit passes; and
a control unit configured to drive (i) the one or more switch elements using the first on-off signal for which a duty cycle is changed in one period corresponding to a first frequency, and (ii) the plurality of switch elements using the second on-off signal generated through the pulse-width modulation (PWM) based on a carrier wave having a second frequency higher than the first frequency and a modulation wave having a frequency which synchronizes to a frequency of a power grid.

2. The inverter device according to claim 1,
wherein the control unit is configured to selectively execute a first mode in which the second frequency is set to be higher than the first frequency and a second mode in which the first frequency and the second frequency are set to be substantially equal, and set the first frequency and the second frequency in the second mode to be higher than the second frequency in the first mode.
